(19) United States
(12) Patent Application Publication
(10) Pub. No.: US 2009/0214950 A1
(43) Pub. Date: Aug. 27, 2009

(54) Lithium cell

(76) Inventors: William L. Bowden, Nashua, NH (US); Phyllis Bowden, Nashua, NH (US); Rimma Sirotina, Ashland, MA (US); Zhiping Jiang, Westford, MA (US); Leigh Friguglietti, Westfield, MA (US); Thomas N. Koulouris, Belmont, MA (US)

Correspondence Address: MR. BARRY D. JOSEPHS;ATTORNEY AT LAW, 19 NORTH STREET, SALEM, MA, 01970, US

(21) Appl. No.: 12/070,924

(22) Filed: Feb. 22, 2008

(51) Int. Cl. H01M 6/02

(52) U.S. Cl. 429/207

(57) ABSTRACT

A primary electrochemical is disclosed having an anode comprising lithium metal or lithium alloy, a cathode comprising iron disulfide (FeS₂) and carbon particles, and electrolyte. The electrolyte has an additive therein desirably an alkylpyrazole or alkylimidazole. The alkylpryrazole preferably comprises 1,3-dimethylpyrazole or 1,3,5-trimethylpyrazole or mixtures thereof and the alkylimidazole preferably comprises 1,2-dimethylimidazole. A preferred electrolyte comprises a lithium salt dissolved in a solvent mixture comprising 1,3-dioxolane and sulfolane and said additive. The cell has the anode and cathode typically in wound configuration with a separator therebetween.

### FIELD OF THE INVENTION

The invention relates to lithium primary cells having an anode comprising lithium and a cathode comprising iron disulfide and an electrolyte comprising a lithium salt and organic solvent which includes an alkylpyrazole or alkylimidazole additive.

### BACKGROUND

Primary (non-rechargeable) electrochemical cells having an anode of lithium are known and are in widespread commercial use. The anode is comprised essentially of lithium metal. Such cells typically have a cathode comprising manganese dioxide, and electrolyte comprising a lithium salt such as lithium trifluoromethane sulfonate (LiCF₃SO₃) dissolved in a nonaqueous solvent. The cells are referenced in the art as primary lithium cells (primary Li/MnO₂ cells) and are generally not intended to be rechargeable. Alternative primary lithium cells with lithium metal anodes but having different cathodes, are also known. Such cells, for example, have cathodes comprising iron disulfide (FeS₂) and are designated Li/FeS₂ cells. The iron disulfide (FeS₂) is also known as pyrite. The Li/MnO₂ cells or Li/FeS₂ cells are typically in the form of cylindrical cells, typically an AA size cell or 2/3A size cell. The Li/MnO₂ cells have a voltage of about 3.0 volts which is twice that of conventional Zn/MnO₂ alkaline cells and also have higher energy density (watt-hrs per cm³ of cell volume) than that of alkaline cells. The Li/FeS₂ cells have a voltage (fresh) of between about 1.2 and 1.5 volts which is about the same as a conventional Zn/MnO₂ alkaline cell. However, the energy density (watt-hrs per cm³ of cell volume) of the Li/FeS₂ cell is much higher than a comparable size Zn/MnO₂ alkaline cell. The theoretical specific capacity of lithium metal is high at 3861.4 mAmp-hr/gram and the theoretical specific capacity of FeS₂ is 893.5 mAmp-hr/gram. The FeS₂ theoretical capacity is based on a 4 electron transfer from 4Li per FeS₂ molecule to result in reaction product of elemental iron Fe and 2Li₂S. That is, 2 of the 4 electrons reduce the oxidation state (valence) of Fe⁺² in FeS₂ from +2 to 0 in elemental iron Fe⁰ and the remaining 2 electrons reduce the oxidation state (valence) of sulfur from −1 in FeS₂ to −2 in Li₂S. In order to carry out the electrochemical reaction the lithium ions, Li⁺, produced at the anode must transport through the separator and electrolyte medium and to the cathode.

Overall the Li/FeS₂ cell is much more powerful than the same size Zn/MnO₂ alkaline cell. That is for a given continuous current drain, particularly for higher current drain over 200 milliAmp, in the voltage vs. time profile the voltage drops off much less quickly for the Li/FeS₂ cell than the Zn/MnO₂ alkaline cell. This results in a higher energy output obtainable from a Li/FeS₂ cell compared to that obtainable for a same size alkaline cell. The higher energy output of the Li/FeS₂ cell is also clearly shown more directly in graphical plots of energy (Watt-hrs) versus continuous discharge at constant power (Watts) wherein fresh cells are discharged to completion at fixed continuous power outputs ranging from as little as 0.01 Watt to 5 Watt. In such tests the power drain is maintained at a constant continuous power output selected between 0.01 Watt and 5 Watt. (As the cell's voltage drops during discharge the load resistance is gradually decreased raising the current drain to maintain a fixed constant power output.) The graphical plot Energy (Watt-Hrs) versus Power Output (Watt) for the Li/FeS₂ cell is considerably above that for the same size alkaline cell. This is despite that the starting voltage of both cells (fresh) is about the same, namely, between about 1.2 and 1.5 volt.

Thus, the Li/FeS₂ cell has the advantage over same size alkaline cells, for example, AAA, AA, C or D size or any other size cell in that the Li/FeS₂ cell may be used interchangeably with the conventional Zn/MnO₂ alkaline cell and will have greater service life, particularly for higher power demands. Similarly the Li/FeS₂ cell which is primary (nonrechargeable) cell can be used as a replacement for the same size rechargeable nickel metal hydride cells, which have about the same voltage (fresh) as the Li/FeS₂ cell.

The Li/FeS₂ cell is normally balanced so that the theoretical capacity of the cathode (mAmp-hrs) is greater than the theoretical capacity of the anode (mAmp-hrs). This is because the utilization (discharge efficiency) of the cathode is normally expected to be less than that of the lithium anode. Computation of the theoretical capacity of the anode involves computing the ideal capacity (mAmp-hrs) of all the anode active materials therein, and the theoretical capacity of the cathode involves computing the ideal capacity (mAmp-hrs) of all the cathode active materials therein. It shall be understood that the use of such terms theoretical capacity of anode and theoretical capacity of cathode as used in the present application shall be so defined. The “anode active” materials and “cathode active” materials are defined as the materials in the anode and cathode, respectively, which are capable of useful electrochemical discharge. That is, the “anode active materials” and “cathode active materials” promote current flow between the cell's negative and positive terminals when an external circuit between these terminals is connected and the cell is used in normal manner. It is understood that only those portions of the anode and cathode which are dischargeable, that is, which face each other with separator therebetween, are included in the calculation of the theoretical capacity.

The Li/MnO₂ cell and Li/FeS₂ cell both normally utilize non aqueous electrolytes, since the lithium anode is reactive with water. One of the difficulties associated with the manufacture of a Li/FeS₂ cell is the need to add good binding material to the cathode formulation to bind the Li/FeS₂ and carbon particles together in the cathode. The binding material must also be sufficiently adhesive to cause the cathode coating to adhere uniformly and strongly to the conductive substrate to which it is applied.

The cathode material may be initially prepared in a form such as a slurry mixture, which can be readily coated onto a metal conductive substrate by conventional coating methods. The electrolyte added to the cell must be a suitable electrolyte for the Li/FeS₂ system allowing the necessary electrochemical reactions to occur efficiently over the range of high power output desired. The electrolyte must exhibit good ionic conductivity and also be sufficiently stable, that is non reactive, with the undischarged electrode materials (anode and cathode components) and also non reactive with the discharge products. This is because undesirable oxidation/reduction reactions between the electrolyte and electrode materials (either discharged or undischarged) could thereby gradually contaminate the electrolyte and reduce its effectiveness or result in excessive gassing. This in turn can result in a catastrophic cell failure. Thus, the electrolyte used in Li/FeS₂ cell in addition to promoting the necessary electrochemical reactions, should also be stable to discharged and undischarged electrode materials. Additionally, the electrolyte should enable good ionic mobility and transport of the lithium ion (Li⁺) from anode to cathode so that it can engage in the necessary reduction reaction resulting in LiS₂ product in the cathode.

Primary lithium cells are in use as a power source for digital flash cameras, which require operation at higher pulsed power demands than is supplied by individual alkaline cells. Primary lithium cells are conventionally formed of an electrode composite comprising an anode formed of a sheet of lithium, a cathode formed of a coating of cathode active material comprising FeS₂ on a conductive metal substrate (cathode substrate) and a sheet of electrolyte permeable separator material therebetween. The electrode composite may be spirally wound and inserted into the cell casing, for examples, as shown in U.S. Pat. No. 4,707,421. A cathode coating mixture for the Li/FeS₂ cell is described in U.S. Pat. No. 6,849,360. A portion of the anode sheet is typically electrically connected to the cell casing which forms the cell's negative terminal. The cell is closed with an end cap which is insulated from the casing. The cathode sheet can be electrically connected to the end cap which forms the cell's positive terminal. The casing is typically crimped over the peripheral edge of the end cap to seal the casing's open end. The cell may be fitted internally with a PTC (positive thermal coefficient) device or the like to shut down the cell in case the cell is exposed to abusive conditions such as short circuit discharge or overheating.

The anode in a Li/FeS₂ cell can be formed by laminating a layer of lithium on a metallic substrate such as copper. However, the anode may be formed of a sheet of lithium without any substrate.

The electrolyte used in a primary Li/FeS₂ cells are formed of a “lithium salt” dissolved in an “organic solvent”. Representative lithium salts which may be used in electrolytes for Li/FeS₂ primary cells are referenced in U.S. Pat. No. 5,290,414 and U.S. Pat. No. 6,849,360 B2 and include such salts as: Lithium trifluoromethanesulfonate, LiCF₃SO₃ (LiTFS); lithium bistrifluoromethylsulfonyl imide, Li (CF₃SO₂)₂N (LiTFSI); lithium iodide, LiI; lithium bromide, LiBr; lithium tetrafluoroborate, LiBF₄; lithium hexafluorophosphate, LiPF₆; lithium hexafluoroarsenate, LiAsF₆; Li(CF₃SO₂)₃C, and various mixtures. In the art of Li/FeS₂ electrochemistry lithium salts are not always interchangeable as specific salts work best with specific electrolyte solvent mixtures.

In U.S. Pat. No. 5,290,414 (Marple) is reported use of a beneficial electrolyte for FeS₂ cells, wherein the electrolyte comprises a lithium salt dissolved in a solvent comprising 1,3-dioxolane in admixture with a second solvent which is an acyclic (non cyclic) ether based solvent. The acyclic (non cyclic) ether based solvent as referenced may be dimethoxyethane (DME), ethyl glyme, diglyme and triglyme, with the preferred being 1,2-dimetoxyethane (DME). As given in the example the 1,2-dimethoxyethane (DME) is present in the electrolyte in substantial amount, i.e., at either 40 or 75 vol. % (col. 7, lines 47-54). A specific lithium salt ionizable in such solvent mixture(s), as given in the example, is lithium trifluoromethane sulfonate, LiCF₃SO₃. Another lithium salt, namely lithium bistrifluoromethylsulfonyl imide, Li(CF₃SO₂)₂N also mentioned at col. 7, line 18-19. The reference teaches that a third solvent may optionally be added selected from 3,5-dimethlyisoxazole (DMI), 3-methyl-2-oxazolidone; propylene carbonate (PC), ethylene carbonate (EC), butylene carbonate (BC), tetrahydrofuran (THF), diethyl carbonate (DEC), ethylene glycol sulfite (EGS), dioxane, dimethyl sulfate (DMS), and sulfolane (claim 19) with the preferred being 3,5-dimethylisoxazole.

In U.S. Pat. No. 6,849,360 B2 (Marple) is disclosed a specific preferred electrolyte for an Li/FeS₂ cell, wherein the electrolyte comprises the salt lithium iodide dissolved in the organic solvent mixture comprising 1,3-dioxolane (DX), 1,2-dimethoxyethane (DME), and small amount of 3,5 dimethylisoxazole (DMI). (col. 6, lines 44-48.) The electrolyte is typically added to the cell after the dry anode/cathode spiral with separator therebetween is inserted into the cell casing.

In US 2007/0202409 A1 (Yamakawa) it is stated with reference to the electrolyte solvent for the Li/FeS₂ cell at para. 33: “Examples of the organic solvent include propylene carbonate, ethylene carbonate, 1,2-dimethoxy ethane, γ-butyrolactone, tetrahydrofuran, 2-methyl tetrahydrofuran, 1,3 dioxolane, sulfolane, acetonitrile, dimethyl carbonate, and dipropyl carbonate, and any one of them or two or more of them can be used independently, or in a form of a mixed solvent.” Such statement is misleading, since the art teaches only specific combinations of electrolyte solvents will be workable for the Li/FeS₂ cell depending on the particular lithium salt to be dissolved in the solvent. (See, e.g. above U.S. Pat. No. 5,290,414 and U.S. Pat. No. 6,849,360) The reference Yamakawa does not teach which combination of solvents from the above list are to be used with any given lithium salt.

Thus, it should be evident from the above representative references that the choice of a particular solvent or mixture of different organic solvents for use in conjunction with any one or more lithium salts to produce a suitable electrolyte for the Li/FeS₂ cell is challenging. This is not to say that many combinations of lithium salts and organic solvents will not work at all in a Li/FeS₂ cell. But rather such cells using an electrolyte formed with just any combination of known lithium salt and any combination of organic solvents is that the problems encountered will likely be very substantial, thus making the cell impractical for commercial usage. Thus, references which merely provide long lists of possible organic solvents for Li/FeS₂ cells do not necessarily teach combinations of solvents or combination of specific lithium salts in specific solvent mixtures, which exhibit particular or unexpected benefit.

Accordingly, it is desired to produce a Li/FeS₂ cell employing an effective electrolyte therein which promotes ionization of the lithium salt in the electrolyte and is sufficiently stable that it does not degrade with time and does not degrade the anode or cathode components.

It is desired that the electrolyte comprising a lithium salt dissolved in an organic solvent provide for good ionic mobility of the lithium ions through the electrolyte so that the lithium ions may pass at good transport rate from anode to cathode through the separator.

It is desired to include an additive into the electrolyte which retards the rate of buildup of a deleterious passivation layer on the surface of the lithium anode, thereby stabilizing the cell and helping to achieve reliable cell performance.

It is desired to produce a primary (nonrechargeable) Li/FeS₂ cell having good rate capability that the cell may be used in place of rechargeable batteries to power digital cameras.

### SUMMARY OF THE INVENTION

The invention is directed to lithium primary cells wherein the anode comprises lithium metal. The lithium may be alloyed with small amounts of other metal, for example aluminum, which typically comprises less than about 1 wt. % of the lithium alloy. The lithium which forms the anode active material, is preferably in the form of a thin foil. The cell has a cathode comprising the cathode active material iron disulfide (FeS₂), commonly known as “pyrite”. The cell may be in the form of a button (coin) cell or flat cell. Desirably the cell may be in the form of a spirally wound cell comprising an anode sheet and a cathode composite sheet spirally wound with electrolyte permeable separator therebetween. The cathode sheet is produced using a slurry process to coat a cathode mixture comprising iron disulfide (FeS₂) particles onto a conductive surface which can be a conductive metal substrate. The FeS₂ particles are bound to the conductive substrate using desirably an elastomeric, preferably, a styrene-ethylene/butylene-styrene (SEBS) block copolymer such as Kraton G1651 elastomer (Kraton Polymers, Houston, Tex.). This polymer is a film-former, and possesses good affinity and cohesive properties for the FeS₂ particles as well as for conductive carbon particle additives in the cathode mixture.

In an aspect of the invention the cathode is formed of a cathode slurry comprising iron disulfide (FeS₂) powder, conductive carbon particles, binder material, and solvent. (The term “slurry” as used herein will have its ordinary dictionary meaning and thus be understood to mean a wet mixture comprising solid particles.) The wet cathode slurry is coated onto a conductive substrate such as a sheet of aluminum or stainless steel. The conductive substrate functions as a cathode current collector. The solvent is then evaporated leaving dry cathode coating mixture comprising the iron disulfide material and carbon particles preferably including carbon black adhesively bound to each other and with the dry coating bound to one or both sides of the conductive substrate. The preferred carbon black is acetylene black. The carbon may optionally include graphite particles blended therein.

After the wet cathode slurry is coated onto the conductive substrate, the coated substrate is placed in an oven and heated at elevated temperatures until the solvent evaporates, as disclosed in commonly assigned U.S. patent application Ser. No. 11/516,534, filed Sep. 6, 2006. The-resulting product is a dry cathode coating comprising iron disulfide and carbon particles bound to the conductive substrate. On a dry basis, the cathode preferably contains no more than 4% by weight binder, and between 85 and 95% by weight of FeS₂. The solids content, that is, the FeS₂ particles and conductive carbon particles in the wet cathode slurry is between 55 and 70 percent by weight. The viscosity range for the cathode slurry is from about 3500 to 15000 mPas. (mPas=mNewton×sec/m²). After the anode comprising lithium metal and cathode comprising iron disulfide, with separator therebetween, are inserted into the cell housing, a nonaqueous electrolyte is added to the cell.

In a principal aspect of the invention the desired electrolyte for the lithium/iron disulfide (Li/FeS₂) cell comprises a lithium salt dissolved in an organic solvent mixture which includes the electrolyte additive of the invention. A preferred electrolyte to which the additive of the invention may be added comprises a lithium salt dissolved in a solvent mixture comprising 1,3-dioxolane and sulfolane. The lithium salt may be selected from LiCF₃SO₃ (LiTFS), Li(CF₃SO₂)₂N (LiTFSI), LiI, LiPF₆, LiBr, and LiBF₆. Desirably the lithium salt comprises LiCF₃SO₃ (LiTFS) or Li(CF₃SO₂)₂N (LiTFSI), preferably Li(CF₃SO₂)₂N (LiTFSI).

The electrolyte additive of the invention comprises an alkylpyrazole or alkylimidazole or mixture thereof. The alkypyrazole preferably comprises 1,3-dimethylypyrozole or 1,3,5-trimethylpyrozole or mixtures thereof. The alkylimidazole preferably comprises 1,2-dimethylimidazole. It has been determined that when alkylpyrozole, preferably 1,3-dimethylypyrozole or 1,3,5-trimethylpyrozole or mixtures thereof or an alkylimidazole preferably comprising 1,2-dimethylimidazole is added to the electrolyte the additive can improve the properties of the electrolyte for use in the primary lithium/iron disulfide cell. The electrolyte additive of the invention comprising said alkylpyrazole or alkylimidazole or mixtures thereof comprises between about 0.05 to 1 wt. %, preferably between about 0.1 and 1.0 wt % of the total electrolyte. In particular the preferred additives 1,3-dimethylpyrozole or 1,3,5-trimethylpyrazole or 1,2-dimethylimidazole may be added alone or in any mixture combination so that the additive amount comprises between about 0.05 to 1 wt. %, preferably between about 0.1 and 1.0 wt % of the total electrolyte. In particular the above named additives of the invention appear to be particularly suitable for addition to an electrolyte solvent mixture comprising 1,3-dioxolane and sulfolane, preferably comprising between about 70 and 90 vol % 1,3-dioxolane and between about 10 and 30 vol % sulfolane. The electrolyte salt is preferably LiCF₃SO₃ (LiTFS) or Li(CF₃SO₂)₂N (LiTFSI), more preferably the latter.

The alkylpyrazole or alkylimidazole additive to the electrolyte for the Li/FeS₂ cell retards the rate of buildup of a passivation layer on the surface of the lithium anode. The additive also prevents or reduces the chance of polymerization of dioxoloane solvent which may be present in the electrolyte. This in turn improves cell performance and capacity of the primary lithium/iron disulfide cell.

### BRIEF DESCRIPTION OF THE DRAWINGS

FIG. 1 is an isometric view of an improved Li/FeS₂ cell of the invention as presented in a cylindrical cell embodiment.

FIG. 2 is a partial cross sectional elevation view of the cell taken through sight lines 2-2 of FIG. 1 to show the top and interior portion of the cell.

FIG. 3 is a partial cross sectional elevation view of the cell taken through sight lines 2-2 of FIG. 1 to show a spirally wound electrode assembly.

FIG. 4 is a schematic showing the placement of the layers comprising the electrode assembly.

FIG. 5 is a plan view of the electrode assembly of FIG. 4 with each of the layers thereof partially peeled away to show the underlying layer.

### DETAILED DESCRIPTION

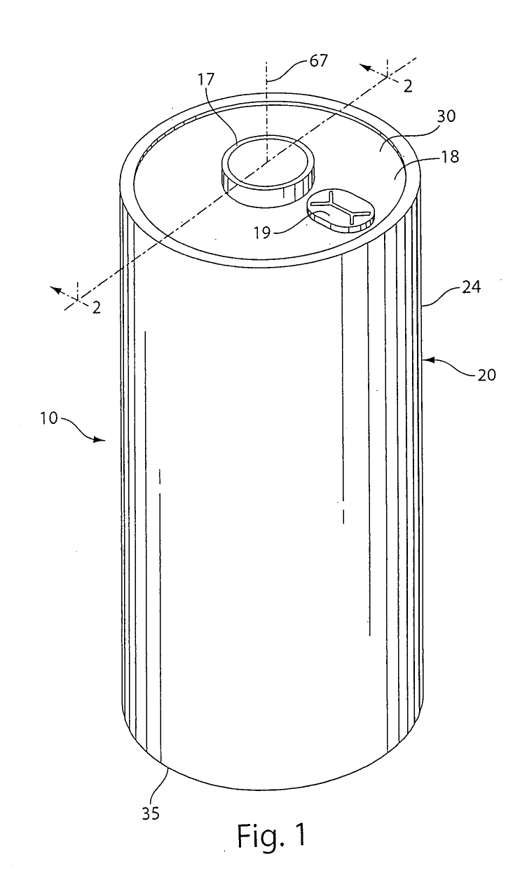

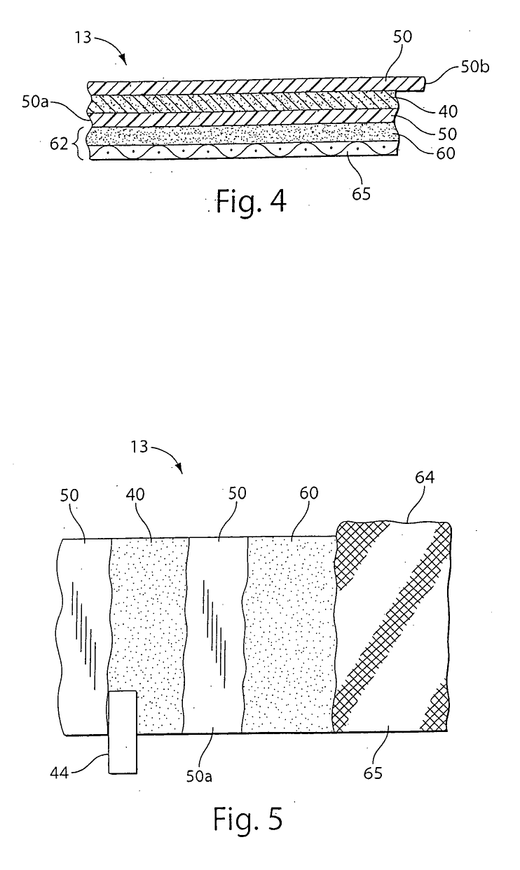

The Li/FeS₂ cell of the invention is desirably in the form of a spirally wound cell as shown in FIGS. 1-5. A desirable wound cell 10 configuration comprising a lithium anode 40 and a cathode composite 62 comprising iron disulfide (FeS₂) with separator sheet 50 therebetween is shown in the figures. The anode may comprise a sheet of lithium or lithium alloy 40. The cathode composite may comprise a coating of cathode material 60 comprising iron disulfide (FeS₂) which is coated on at least one side of a substrate 65 as shown best in FIGS. 4 and 5. The cathode material 60 may also be coated on both sides of substrate 65. The substrate or grid 65 is preferably an electrically conductive substrate, such as a sheet of aluminum, or stainless steel foil. The conductive substrate 65 may be a continuous solid sheet without apertures or may be a sheet with apertures therein. For example, substrate 65 may be formed from expanded stainless steel foil or expanded aluminum foil or from piercing the sheet with small apertures.

The anode 40 can be prepared from a solid sheet of lithium metal. The anode 40 is desirably formed of a continuous sheet of lithium metal (99.8% pure). Alternatively, the anode 40 can be an alloy of lithium and an alloy metal, for example, an alloy of lithium and aluminum or an alloy of lithium and calcium or an alloy of lithium and tin. In such case the alloy metal, is present in very small quantity, preferably less than 1 or 2 percent by weight of the lithium alloy. Upon cell discharge the lithium in the alloy thus functions electrochemically as pure lithium. Thus, the term “lithium or lithium metal” as used herein and in the claims is intended to include in its meaning such lithium alloy. The lithium sheet forming anode 40 does not require a substrate. The lithium anode 40 can be advantageously formed from an extruded sheet of lithium metal having a thickness of desirably between about 0.10 and 0.20 mm, preferably about 0.15 mm for the spirally wound cell.

The Li/FeS₂ cell as in cell 10 has the following basic discharge reactions (one step mechanism):

Anode:

4Li=4Li⁺+4e⁻ Eq. 1

### Cathode:

FeS₂+4Li⁺+4e⁻=Fe+2Li₂S Eq. 2

Overall:

FeS₂+4Li=Fe+2Li₂S Eq. 3

The theoretical specific capacity (mAmp-hr/g) of FeS₂ can be calculated as follows based on a 4 electron transfer per molecule, wherein 2 electrons reduce Fe⁺² to elemental iron Fe and 2 electrons reduce S⁻¹ to 2S⁻² forming Fe+2Li₂S. The molecular weight (M.W.) of FeS₂ is 119.98 and the M.W. of Li is 6.941. The charge qₒ of an electron is 1.602×10⁻¹⁹ coulomb. 1 coulomb=1 Amp-sec. Avogadro's number A₀ is 6.023×10²³ molecules per mol. Let F=(qₒ×A₀)/3600 sec/hr=26.802 Amp-hr. The theoretical specific capacity of FeS₂ can be calculated as 26.802×4/119.98=0.8935 Amp-hr/g=893.5 mAmp-hr/g. The theoretical specific capacity of Li can be calculated as 26.802×1/6.941=3.8614 Amp-hr/g=3861.4 mAmp-hr/g. In a specific embodiment herein lithium is the only anode active material and FeS₂ is the only cathode active material. In that case the theoretical capacity of the anode is the theoretical specific capacity of lithium times the weight of lithium facing the cathode with separator therebetween so that the lithium is dischargable. The theoretical capacity of the cathode is the theoretical specific capacity of the FeS₂ times the weight of FeS₂ in the cathode facing the anode with separator therebetween so that the FeS₂ is dischargeable.

In general the theoretical capacity of the anode involves computing the ideal capacity (mAmp-hrs) of all the anode active materials therein, and the theoretical capacity of the cathode involves computing the ideal capacity (mAmp-hrs) of all the cathode active materials therein. It shall be understood that the use of such terms theoretical capacity of anode and theoretical capacity of cathode as used in the present application shall be so defined. The “anode active” materials and “cathode active” materials are defined as the materials in the anode and cathode, respectively, which are capable of useful electrochemical discharge. That is, the “anode active materials” and “cathode active materials” promote current flow between the cell's negative and positive terminals when an external circuit between these terminals is connected and the cell is used in normal manner.

The Li/FeS₂ cylindrical cell 10 may be in the form of a primary (nonrechargeable) cell.

The cathode material 60 of the invention comprising iron disulfide (FeS₂) or any mixture including iron disulfide (FeS₂) as active cathode material, may thus be coated onto one or both sides of conductive substrate 65 to form cathode composite sheet 62. The cathode active material, that is, the material undergoing useful electrochemical reaction, in cathode 60 can be composed entirely of iron disulfide (FeS₂) or may include another coactive material. The cathode 60 comprising iron disulfide (FeS₂) powder dispersed therein can be prepared in the form of a wet slurry comprising a mixture of iron disulfide powder, carbon particles, polymeric binder and solvents mixed therein. The wet slurry is coated on one side of the conductive metal substrate 65, preferably an aluminum or stainless steel foil as above indicated. The wet coating 60 on substrate 65 may then be dried in a conventional convective air oven to evaporate the solvents. Then a coating of the wet slurry may optionally also be applied to the opposite side (not shown) of conductive substrate 65. In such case the wet coating on the opposite side of conductive substrate 65 is similarly dried in a convective air oven to evaporate solvents. The cathode composite sheet 62 is finally formed with dry cathode coating 60 on one or both sides of conductive substrate 65. The cathode composite sheet 62 can then be subjected to calendering resulting in a compacted smooth dry cathode coating 60 on conductive substrate 65.

The cathode slurry desirably comprises 2 to 4 wt % of binder (Kraton G1651 elastomeric binder from Kraton Polymers, Houston Tex.); 50 to 70 wt % of active FeS₂ powder; 4 to 7 wt % of conductive carbon (carbon black and graphite); and 25 to 40 wt % of solvent(s). (The carbon black is preferably acetylene carbon black. However, the carbon black may include in whole or in part other carbon black, such as carbon black made from the incomplete combustion or thermal decomposition of natural gas or petroleum oil. Thus, the term carbon black as used herein shall be understood to extend to and include acetylene black and such other carbon black.) The Kraton G1651 binder is a polymeric elastomeric block copolymer (styrene-ethylene/butylene (SEBS) block copolymer) which is a film-former. The Kraton polymeric binder is soluble in the solvents employed in forming the wet cathode slurry. Kraton binder has excellent film forming properties and readily disperses over the iron disulfide particles and conductive carbon particles to help keep these particles in contact with each other. That is, the binder possesses sufficient affinity for the active FeS₂ and carbon black particles to facilitate preparation of the wet cathode slurry and to keep these particles in contact with each other in a network after the solvents are evaporated. The Kraton binder is also stable in the electrolyte which is subsequently added to cell after the anode 40, cathode 62 with separator 50 therebetween are wound and inserted into the cell casing. The Kraton binder is chemically and electrochemically resistant so that it does not react with the electrolyte or other cell contents during cell storage or discharge, even over a wide range of environmental conditions between about −10° C. and 60° C.

The FeS₂ powder may have an average particle size between about 1 and 100 micron, desirably between about 10 and 50 micron and a BET surface area typically between about 0.8 and 1.5 m²/g. A desirable FeS₂ powder is available under the trade designation Pyrox Red 325 powder from Chemetall GmbH, wherein the FeS₂ powder has a particle size sufficiently small that at least 90% of particles will pass through a sieve of Tyler mesh size 325 (sieve openings of 0.045 mm). (The residue amount of FeS₂ particles not passing through the 325 mesh sieve is 10% max.) The Pyrox Red 325 FeS₂ had an average particle size of between about 20 and 26 micron and a typical BET surface area of about 1.1 m²/g and density of 4.7 gm/cm³. The graphite is available under the trade designation TIMREX KS6 graphite from Timcal America. TIMREX graphite is a fairly high crystalline synthetic graphite, BET surface area 20 m²/g, density 2.25 g/cm³. (Other graphites may be employed selected from natural, synthetic, or expanded graphite and mixtures thereof, but the TIMREX graphite from Timcal is preferred because of its high purity.) The carbon black is preferably an acetylene black available under the trade designation Super P conductive carbon black (BET surface area of 62 m²/g, bulk density in bag 0.160 g/cm^{3,}) from Timcal Co. Super P acetylene black has a pH of about 10 as measured by ASTM D1512-95. Other suitable carbon blacks are available from Timcal Co. under the trade designations ENSACO Granular, ENSACO P, SUPER S, SUPER S—Li, and SUPER P—Li. These latter carbon blacks have a pH of between about 6 and 11 as measured by ASTM-D1512 or the equivalent International Standard Ref. No. ISO 787/9-1981(E).

Hydrocarbon solvents are mixed into the FeS₂ powder, carbon particles, and polymeric binder to form the wet cathode slurry to be coated onto substrate 65 as above indicated. In a preferred mixing sequence solvents are mixed first with binder to form a binder/solvent mixture. FeS₂ and carbon particles may be separately premixed and then added to the binder/solvent mixture. The solvents preferably include a mixture of C₉-C₁₁, (predominately C₉) aromatic hydrocarbons available as ShellSol A100 hydrocarbon solvent (Shell Chemical Co.) and a mixture of primarily isoparaffins (average M.W. 166, aromatic content less than 0.25 wt. %) available as Shell Sol OMS hydrocarbon solvent (Shell Chemical Co.). The weight ratio of ShellSol A100 to ShellSol OMS solvent is desirably at a 4:6 weight ratio. The ShellSol A100 solvent is a hydrocarbon mixture containing mostly aromatic hydrocarbons (over 90 wt % aromatic hydrocarbon), primarily C₉ to C₁₁ aromatic hydrocarbons. The ShellSol OMS solvent is a mixture of isoparaffin hydrocarbons (98 wt. % isoparaffins, M.W. about 166) with less than 0.25 wt % aromatic hydrocarbon content. The slurry formulation may be dispersed using a double planetary mixer. Dry powders (FeS₂ powder and carbon particles) are first blended to ensure uniformity before being added to the Kraton G1651 binder solution in the mixing bowl. The solvents are then added and the components blended in the mixer and until a homogeneous slurry mixture is obtained.

A preferred cathode wet slurry mixture by way of non limiting example is presented in Table 1:

TABLE I
Cathode Composition

| | Wet Cathode | |
|---|---|---|
| | Slurry | Dry Cathode |
| | (wt. %) | (wt. %) |
| Binder | 2.0 | 3.01 |
| (Kraton G1651) | | |
| Hydrocarbon Solvent | 13.4 | 0.0 |
| (ShellSol A100) | | |
| (ShellSol OMS) | 20.2 | 0.0 |
| FeS₂ Powder | 58.9 | 88.71 |
| (Pyrox Red 325) | | |
| Graphite | 4.0 | 6.02 |
| (Timrex KS6) | | |
| Acetylene Carbon | 1.5 | 2.26 |
| Black (Super P) | | |
| Total | 100.0 | 100.00 |

This same or similar wet cathode slurry mixture (electrolyte not yet added to the cell) is disclosed in commonly assigned application Ser. No. 11/516,534, filed Sep. 6, 2006. The total solids content of the wet cathode slurry mixture as shown in above Table 1 is 66.4 wt. %. Thus, the acetylene black content in the dry cathode would be 2.26 wt. % and the graphite content in the dry cathode would be 6.02 wt. %.

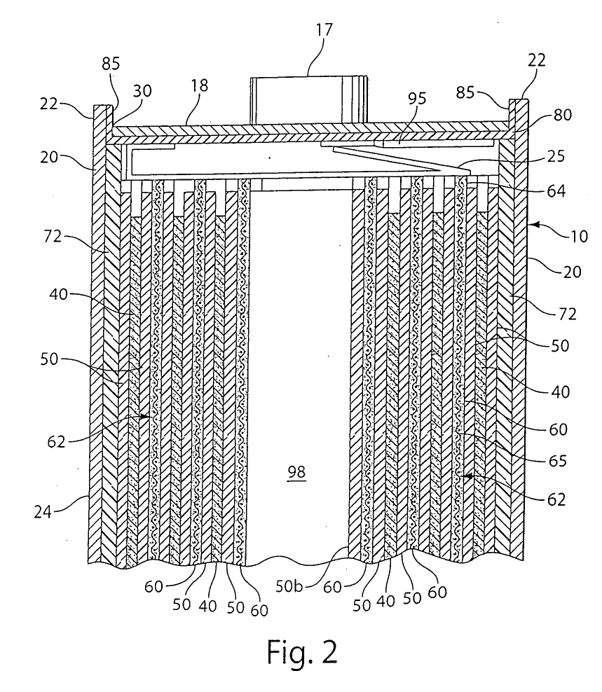

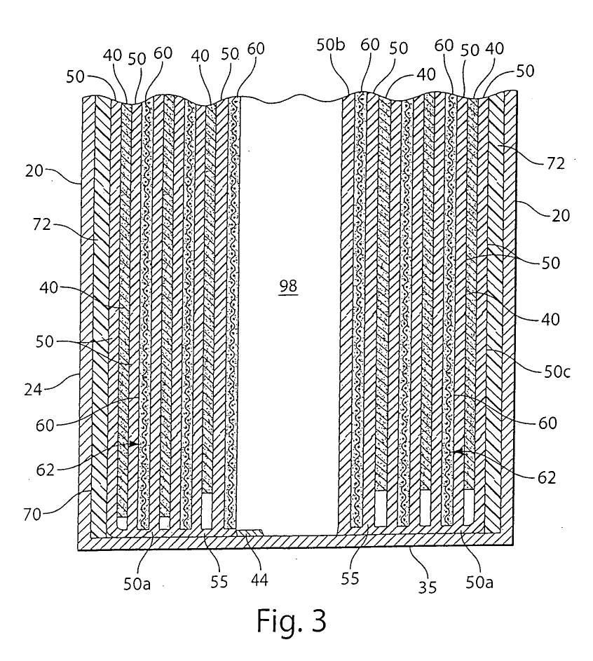

The cylindrical cell 10 may have a spirally wound electrode assembly 70 (FIG. 3) comprising anode sheet 40, cathode composite 62 with separator sheet 50 therebetween as shown in FIGS. 2-5. The Li/FeS₂ cell 10 internal configuration, apart from the difference in cathode composition, may be similar to the spirally wound configuration shown and described in U.S. Pat. No. 6,443,999. The anode sheet 40 as shown in the figures comprises lithium metal or lithium alloy and the cathode sheet 60 comprises iron disulfide (FeS₂) commonly known as “pyrite”. The cell is preferably cylindrical as shown in the figures and may be of any size, for example, AAAA (42×8 mm), AAA (44×9 mm), AA (49×12 mm), C (49×25 mm) and D (58×32 mm) size. Thus, cell 10 depicted in FIG. 1 may also be a 2/3 A cell (35×15 mm) or other cylindrical size. However, it is not intended to limit the cell configuration to cylindrical shape. Alternatively, the cell of the invention may have a spirally wound electrode assembly formed of an anode comprising lithium metal or lithium alloy and a cathode comprising iron disulfide (FeS₂) made as herein described inserted within a prismatic casing, for example, a rectangular cell having the overall shape of a cuboid. The Li/FeS₂ cell is not limited to a spirally wound configuration but the anode and cathode, for example, may be placed in stacked arrangement for use in coin cells.

For a spirally wound cell, a preferred shape of the cell casing (housing) 20 is cylindrical as shown in FIG. 1. Casing 20 is preferably formed of nickel plated steel. The cell casing 20 (FIG. 1) has a continuous cylindrical surface. The spiral wound electrode assembly 70 (FIG. 3) comprising anode 40 and cathode composite 62 with separator 50 therebetween can be prepared by spirally winding a flat electrode composite 13 (FIGS. 4 and 5). Cathode composite 62 comprises a layer of cathode 60 comprising iron disulfide (FeS₂) coated onto metallic substrate 65 (FIG. 4).

The electrode composite 13 (FIGS. 4 and 5) can be made in the following manner: In accordance with the method of the invention the cathode 60 comprising iron disulfide (FeS₂) powder dispersed therein can be initially prepared in the form of a wet slurry which is coated onto a side of conductive substrate sheet 65, preferably a sheet of aluminum or stainless steel which may be a solid sheet with or without apertures therethrough, to form a cathode composite sheet 62 (FIG. 4). Conventional roll coating techniques may be used to coat the wet slurry onto a side of conductive substrate 65 (FIGS. 4 and 5). If an aluminum sheet 65 is used it may be a solid sheet of aluminum without openings therethrough or may be a sheet of expanded or perforated aluminum foil with openings therethrough, thus forming a grid or screen. The apertures in substrate sheet 65 may be the result of punching or piercing holes therein.

The wet cathode slurry mixture having the composition shown above in Table 1 comprising iron disulfide (FeS₂), binder, conductive carbon and hydrocarbon solvents is prepared by mixing the components shown in Table 1 until a homogeneous mixture is obtained.

The above quantities of components (Table 1) of course can be scaled proportionally so that small or large batches of cathode slurry can be prepared. The wet cathode slurry thus preferably has the following composition: FeS₂ powder (58.9 wt. %); Binder, Kraton G1651 (2 wt. %); Graphite, Timrex KS6 (4.0 wt %), Acetylene Black, Super P (1.5 wt %), Hydrocarbon Solvents, ShellSol A100 (13.4 wt %) and ShellSol OMS (20.2 wt %).

The FeS₂ powder (Pyrox Red 325) may be used directly as obtained from the supplier, Chemetall GmbH. Such product may be obtained from the supplier with a CaCO₃ additive already mixed into the FeS₂ powder. The CaCO₃ may typically comprise up to 1.5 wt. % of the FeS₂ powder. The CaCO₃ (or CaCO₃ containing compound) is added by the supplier to raise the pH of the FeS₂ in order to extend its storage life. That is, the elevated pH of FeS₂ resulting from the addition of CaCO₃ is intended to retard the rate of buildup of acidic contaminants within or on the surface of the FeS₂ particles as the FeS₂ is exposed to or stored in ambient air.

After the wet cathode slurry is formed (Table 1), the wet slurry is then coated onto a side of the conductive substrate 65. The conductive substrate 65 with wet cathode slurry coated thereon is then dried in conventional convective oven (or in inert gas) to evaporate the solvents in the slurry, thereby forming a dry cathode coating 60 on one side of conductive substrate 65 (FIGS. 4 and 5). The process is repeated, if desired, to also coat the opposite side of conductive substrate 65 with the wet cathode slurry (Table 1). The wet cathode slurry on the opposite side of conductive substrate 65 can then be subjected to drying in a convective oven to evaporate solvents, thereby forming a dry cathode coating 60 also on the opposite side of conductive substrate 65. The drying of the wet cathode slurry coated on the metal substrate 65 is accomplished preferably by gradually adjusting or ramping up the oven temperature (to avoid cracking the coating) from an initial temperature of 40° C. to a final temperature not to exceed 130° C. for about 7-8 minutes or until the hydrocarbon solvent has substantially all evaporated. (At least about 95 percent by weight of the solvents are evaporated, preferably at least about 99.9 percent by weight of the solvents are evaporated.) The dry cathode coating 60 (whether applied to only one side or both sides of conductive substrate 65) is then subjected to calendering to compress the thickness of said dry cathode coating 60, thus forming the completed cathode composite 62 (FIGS. 4 and 5).

The anode 40 can be prepared from a solid sheet of lithium metal. The anode 40 is desirably formed of a continuous sheet of lithium metal (99.8% pure). The lithium metal in anode 40 may be alloyed with small amounts of other metal, for example aluminum, or calcium which typically comprises less than about 1 or 2 wt. %, and even up to about 5 wt. % of the lithium alloy. The lithium sheet forming anode 40 does not require a substrate. The lithium anode 40 can be advantageously formed from an extruded sheet of lithium metal having a thickness of between about 0.09 and 0.20 mm desirably between about 0.09 and 0.19 mm for the spirally wound cell.

Individual sheets of electrolyte permeable separator material 50, preferably of microporous polypropylene or polyethylene having a thickness of about 0.025 mm or less, desirably between about 0.008 and 0.025 mm, is inserted on each side of the lithium anode sheet 40 (FIGS. 4 and 5). In a preferred embodiment the separator sheet may be microporous polyethylene or polypropylene of thickness about 1 mil (0.025 mm.) The microporous polypropylene desirably has a pore size between about 0.001 and 5 micron. The first (top) separator sheet 50 (FIG. 4) can be designated the outer separator sheet and the second sheet 50 (FIG. 4) can be designated the inner separator sheet. The cathode composite sheet 62 comprising cathode coating 60 on conductive substrate 65 is then placed against the inner separator sheet 50 to form the flat electrode composite 13 shown in FIG. 4. The flat composite 13 (FIG. 4) is spirally wound to form electrode spiral assembly 70 (FIG. 3). The winding can be accomplished using a mandrel to grip an extended separator edge 50b (FIG. 4) of electrode composite 13 and then spirally winding composite 13 clockwise to form wound electrode assembly 70 (FIG. 3).

When the winding is completed separator portion 50b appears within the core 98 of the wound electrode assembly 70 as shown in FIGS. 2 and 3. By way of non limiting example, the bottom edges 50a of each revolution of the separator may be heat formed into a continuous membrane 55 as shown in FIG. 3 and taught in U.S. Pat. No. 6,443,999. As may be seen from FIG. 3 the electrode spiral 70 has separator material 50 between anode sheet 40 and cathode composite 62. The spirally wound electrode assembly 70 has a configuration (FIG. 3) conforming to the shape of the casing body. The spirally wound electrode assembly 70 is inserted into the open end 30 of casing 20 (FIG. 2). As wound, the outer layer of the electrode spiral 70 comprises separator material 50 shown in FIGS. 2 and 3. An additional insulating layer 72, for example, a plastic film such as polyester tape, can desirably be placed over the outer separator layer 50, before the electrode composite 13 is wound. In such case the spirally wound electrode 70 will have insulating layer 72 in contact with the inside surface of casing 20 (FIGS. 2 and 3) when the wound electrode composite is inserted into the casing. Alternatively, the inside surface of the casing 20 can be coated with electrically insulating material 72 before the wound electrode spiral 70 is inserted into the casing.

An electrolyte mixture can then be added to the wound electrode spiral 70 after it is inserted into the cell casing 20. The desired electrolyte comprises a lithium salt LiCF₃SO₃ (LiTFS) or Li(CF₃SO₂)₂N (LiTFSI) dissolved in an organic solvent. A desirable electrolyte is comprised of a mixture of Li(CF₃SO₂)₂N (LiTFSI) salt dissolved in a solvent mixture of 1,3 dioxolane (80 vol %) and sulfolane (20 vol %), as in commonly assigned U.S. patent application Ser. No. 11/494,244. (Pyridine is disclosed as an electrolyte additive in application Ser. No. 11/494,244.) Other lithium salts which could be dissolved in a mixture of 1,3 dioxolane and sulfolane are LiCF₃SO₃ (LiTFS), LiI, LiPF₆, LiBr, and LiBF₆.

The electrolyte additive of the invention comprises an alkylpyrazole or alkylimidazole or combination thereof. The alkylpyrazole preferably comprises 1,3-dimethylpyrozole or 1,3,5-trimethylpyrazole or mixtures thereof. The alkylimidazole preferably comprises 1,2-dimethylimidazole. The additives preferably, 1,3-dimethylpyrozole, or 1,3,5-trimethylpyrazole, or 1,2-dimethylimidazole or any mixture combination thereof is added so that the total additive content is between about 0.05 to 1 wt. %, preferably between about 0.1 and 1.0 wt % of the electrolyte. In particular the 1,3-dimethylpyrozole and 1,3,5-trimethylpyrazole may be added in mixture combination in total amount between about 0.05 to 1 wt. %, preferably between about 0.1 and 1.0 wt % of the electrolyte. In particular the above named additives of the invention appear to be particularly suitable for addition to an electrolyte solvent mixture comprising 1,3-dioxolane and sulfolane, preferably comprising between about 70 and 80 vol % 1,3-dioxolane and between about 20 and 30 vol % sulfolane. The lithium salt in the electrolyte desirably comprises LiCF₃SO₃ (LiTFS) or Li(CF₃SO₂)₂N (LiTFSI), preferably Li(CF₃SO₂)₂N (LiTFSI). However, the lithium salt may also be selected from LiI, LiPF₆, LiBr, or LiBF₆.

The additive of the invention, preferably 1,3-dimethylpyrozole, or 1,3,5-trimethylpyrazole, or 1,2-dimethylimidazole (alone or in any combination) retards the rate of buildup of a deleterious passivation layer on the lithium anode surface, thus stabilizing the anode. The addition of such additives also prevent or reduce the rate of polymerization of 1,3-dioxolane in the electrolyte. The test cells of the invention employing the additives of the invention in the electrolyte showed very good, stable performance even though batches of test cells were subjected to accelerated storage conditions at elevated temperatures (storage at 60° C for 20 days) before they were discharged.

The preferred electrolyte solvents 1,3-dioxolane and sulfolane have the following chemical and structural formulas:

1,3-dioxolane (DX) is a cyclic diether, also classified as a heterocyclic acetal. It has the chemical formula C₃H₆O₂ and the structural formula (I):

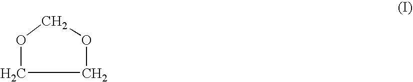

Sulfolane is a cyclic compound having the molecular formula C₄H₈O₂S and a Chemical Abstracts Service Registry (CAS) No. 126-33-0. Sulfolane is a clear colorless liquid having a boiling point of 285° C., a viscosity of 10.28 centipoise (at 30° C.), and a dielectric constant of 43.26 (at 30° C.). The structural formula for sulfolane is represented as follows:

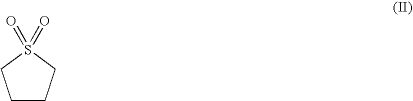

The preferred electrolyte additive of the invention, namely, 1,3-dimethylpyrozole, 1,3,5-trimethylpyrozole, and 1,2-dimethylimidazole have the following chemical and structural formulas:

1,3-dimethylpyrozole is a cyclic compound having the molecular formular C₅H₈N₂. The structural formula is represented as follows:

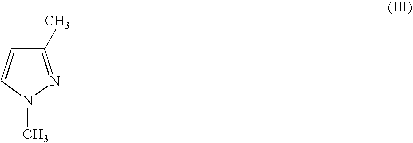

1,3,5-trimethylpyrozole is a cyclic compound having the molecular formular C₆H₁₀N₂. It has a Chemical Abstracts Service Registry No. (CAS) 1072-91-9. The structural formula is represented as follows:

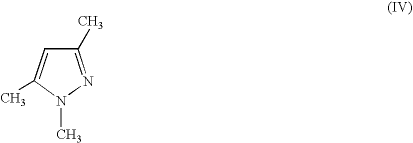

1,2-dimethylimidazole is a cyclic compound having the molecular formula C₅H₈N₂. (Abstracts Registry CAS No. 1739-84-0) The structural formula is represented as follows:

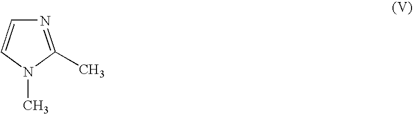

An end cap 18 forming the cell's positive terminal 17 (FIG. 2) may have a metal tab 25 (cathode tab) which can be welded on one of its sides to inside surface of end cap 18. Metal tab 25 is preferably of aluminum or aluminum alloy. A portion of the cathode substrate 65 may be extended along its top edge forming a portion 64 extending from the top of the wound spiral as shown in FIG. 2. The cathode substrate portion 64 can be welded to the exposed side of metal tab 25 before the casing peripheral edge 22 is crimped around the end cap 18 with peripheral edge 85 of insulating disk 80 therebetween to close the cell's open end 30. End cap 18 desirably has a vent 19 (FIG. 1) which can contain a rupturable membrane designed to rupture and allow gas to escape if the gas pressure within the cell exceeds a predetermined level. Positive terminal 17 is desirably an integral portion of end cap 18. Alternatively, terminal 17 can be formed as the top of an end cap assembly of the type described in U.S. Pat. No. 5,879,832, which assembly can be inserted into an opening in the surface of end cap 18 and then welded thereto.

A metal tab 44 (anode tab) as shown in FIG. 5, preferably of nickel, or nickel plated steel, can be pressed into a portion of the lithium metal anode 40. Anode tab 44 can be pressed into the lithium metal at any point within the spiral, for example, it can be pressed into the lithium metal at the outermost layer of the spiral (FIG. 5). Anode tab 44 can be embossed on one side forming a plurality of raised portions on the side of the tab to be pressed into the lithium. The opposite side of tab 44 can be welded to the inside surface of the casing either to the inside surface of the casing side wall 24 or more preferably to the inside surface of closed end 35 of casing 20 as shown in FIG. 3. It is preferable to weld anode tab 44 to the inside surface of the casing closed end 35, since this is readily accomplished by inserting an electrical spot welding probe (an elongated resistance welding electrode) into the cell core 98. Care should be taken to avoid contacting the welding probe to the separator starter tab 50b which is present along a portion of the outer boundary of cell core 98.

The primary lithium cell 10 may optionally also be provided with a PTC (positive thermal coefficient) device 95 located under the end cap 18 and connected in series between the cathode 60 and end cap 18 (FIG. 2). Such device protects the cell from discharge at a current drain higher than a predetermined level. Thus, if the cell is drained at an abnormally high current, e.g., higher than about 6 to 8 Amp in a AA size cell for a prolonged period, the resistance of the PTC device increases dramatically, thus shutting down the abnormally high drain. It will be appreciated that devices other than vent 19 and PTC device 95 may be employed to protect the cell from abusive use or discharge.

### Test Protocol

AA size Li/FeS₂ test cells (49×12 mm) were made fresh as described above. The cathode coating 60 had the composition as shown in Table 1. The cathode 60 was coated on both sides of a sheet of aluminum foil substrate 65 of thickness 1 mil (0.025 mm) without any opening therethrough. The separator was of microporous polypropylene (Celgard 2500) of 1 mil (0.025 mm) thickness. The anode 40 comprised a sheet of lithium metal of approximately 6 mil (0.015 mm) thickness. The cathode contained 4.5 gram iron disulfide (FeS₂) as cathode active material. The cell was balanced so that the ratio of the theoretical capacity of the cathode (mAmp-hrs) to the theoretical capacity of the anode (mAmp-hrs) was 1.25.

A dry electrode assembly 70 comprising spirally wound anode 40, cathode 60 with separator 50 therebetween was inserted into cylindrical casing 20 as above described forming the cell. Then the electrolyte was added to the cell. The electrolyte added to the cell comprised a mixture of Li(CF₃SO₂)₂N (LiTFSI) salt (0.8 mols/liter) dissolved in a solvent mixture of 1,3 dioxolane (80 vol %) and sulfolane (20 vol %), as in commonly assigned U.S. patent application Ser. No. 11/494,244. The additive of the invention was added to the electrolyte in amount of about 0.1 wt % of the electrolyte. The electrolyte mixture was added on the basis of about 0.5 gram electrolyte solution per gram FeS₂ for the spirally wound cell (FIG. 2).

Three batches of AA cells were made and tested, namely, Batch A, B, and C. Each batch contained 6 test cells. The cells were identical in every respect and contained the same anode, cathode, separator and electrolyte composition except that a different additive of the invention was added to the electrolyte of each batch. Specifically, the electrolyte for each batch comprised Li(CF₃SO₂)₂N (LITFSI) salt (0.8 mols/liter) dissolved in a solvent mixture of 1,3 dioxolane (80 vol %) and sulfolane (20 vol %). The Batch A cells also contained 0.2 wt % of 1,3-dimethylpyrozole added to the electrolyte. The Batch B cells contained 0.2 wt. % of 1,3,5-trimethylpyrozole added to the electrolyte. And the Batch C cells contained 0.2 wt % of 1,2-dimethylimidazole added to the electrolyte.

After the Test AA cells were filled, they were predischarged slightly to a depth of discharge of about 3 percent of the cell's capacity. The cells were then subjected to Test Protocol I. In Test Protocol I, the cells were stored at room temperature (20° C.) for 3 days after the predischarged involving 3% of the cell's capacity. The cells were then subjected to the Digicam test described below. The Test AA cells were discharged to a cutoff voltage of about 1.05 Volts using a digital camera discharge test (Digicam test).

The digital camera test (Digicam test) consists of the following pulse test protocol wherein each test cell was drained by applying pulsed discharge cycles to the cell: Each “pulsed cycle” consists of both a 1.5 Watt pulse for 2 seconds followed immediately by a 0.65 Watt pulse for 28 seconds. These cycles are repeated 10 times followed by 55 minutes rest. Then the cycles are repeated until the cutoff voltage is reached. (The test tends to mimic the power of the digital camera required to take and view pictures.) The cycles are continued until a cutoff voltage of 1.05V is reached. The total number of pulsed cycles (corresponds to number of 1.5 watt pulses) required to reach the cutoff voltage were recorded for each batch. The average number of pulsed cycles for the test cells reach a cutoff voltage of about 1.05 volts were as follows: Batch A cells: 561 (pulsed cycles); Batch B cells: 579 (pulsed cycles); Batch C cells: 578 (pulsed cycles). These test results indicate good and consistent cell discharge performance with respect to the applied Digicam test.

Another set of AA size Batch A, Batch B, and Batch C cells, having the same compositions, respectively, as described above, were subjected to another test protocol, namely Test Protocol II. In Test Protocol II, this latter set of cells (6 cells per batch) were initially predischarged using about 3 percent of the cells capacity as in the previous set. However, the cells were then subjected to accelerated storage at 60° C. for 20 days before the Digicam test was applied. The total number of pulsed cycles (corresponds to the number of 1.5 Watt pulses) required to reach the 1.05V cutoff voltage were recorded for each batch. The average number of the pulsed cycles for the latter set of test cells to reach a cutoff voltage of about 1.05 volts were as follows: Batch A cells: 534 (pulsed cycles); Batch B cells: 551 (pulsed cycles); Batch C cells: 545 (pulsed cycles).

The percent loss in average number of pulsed cycles as a result of subjecting the cells to accelerated storage (Test Protocol II) before the Digicam test was applied, is as follows: Batch A cells: 4.8%; Batch B cells: 4.8%, and Batch C cells: 5.7%. The loss in Digicam test performance as a result of subjecting the test cells to accelerated storage conditions is nominal. These good results are thus an indicator that the test cells of the invention are stable and can be expected to function well in digital cameras and the like, even if the cells are subjected to elevated temperature storage conditions (or prolonged storage at ambient temperature) before usage. The test results are summarized in the following Table 2.

TABLE 2
Discharge Test Results for Li/FeS₂ Cells
Digicam Test Results - Total Pulsed
Cycles For Two Different Test Protocols

| | |
|---|---|
| Test AA size | Test Protocol |

| Li/FeS₂ Cells¹ | I² | II³ |
|---|---|---|
| Batch A | | |
| 1,3-dimethylpyrozole | 561 | 534 |
| added to electrolyte | | |
| Batch B | | |
| 1,3,5-trimethylpyrozole | 579 | 551 |
| added to electrolyte | | |
| Batch C | | |
| 1,2-dimethylimidazole | 578 | 545 |
| added to electrolyte | | |

Notes:
¹AA size Li/FeS₂ cylindrical cells, all the same except for indicated additive added as 0.2 wt % of electrolyte. The electrolyte was Li(CF₃SO₂)₂N (LiTFSI) salt (0.8 mols/liter) dissolved in a solvent mixture of 1,3 dioxolane (80 vol %) and sulfolane (20 vol %).
²Group I Tests - After the fresh cells were predischarged (3% of cells capacity) and stored for 3 days at ambient room temperature (20° C.), the cells OCV were measured. The cells were then subjected to the Digicam Test (described above) designed to simulate use in digital cameras. Total number of pulsed cycles are reported. Each pulsed cycle consisted of a 1.5 Watt pulse for 2 seconds followed by a 0.65 Watt pulse for 28 seconds.
³Group II Tests - After the fresh cells were predischarged (3% of cells capacity), the cells were subjected to accelerated storage at 60° C. for 20 days. The cells OCV were measured. The cells were then subjected to the Digicam Test (described above) designed to simulate use in digital cameras. Total number of pulsed cycles are reported. Each pulsed cycle consisted of a 1.5 Watt pulse for 2 seconds followed by a 0.65 Watt pulse for 28 seconds.

Although the invention has been described with reference to specific embodiments, it should be appreciated that other embodiments are possible without departing from the concept of the invention and are thus within the claims and equivalents thereof.

What is claimed is:

1. A primary electrochemical cell comprising a housing; a positive and a negative terminal; an anode comprising at least one of a lithium metal and lithium alloy; a cathode comprising iron disulfide (FeS₂) and conductive carbon, said cell further comprising an electrolyte comprising a lithium salt dissolved in a solvent, wherein said electrolyte comprises an additive comprising an alkylpyrazole.

2. The cell of claim 1 wherein said alkylpyrazole additive is selected from the group consisting of 1,3-dimethylpyrazole and 1,3,5-trimethylpyrazole, and mixtures thereof.

3. The cell of claim 1 wherein said alkylpyrazole additive comprises 1,3-dimethylpyrazole.

4. The cell of claim 1 wherein said alkylpyrazole additive comprises 1,3,5-trimethylpyrazole.

5. The cell of claim 1 wherein said alkylpyrazole comprises between about 0.05 and 1.0 percent by weight of said electrolyte.

6. The cell of claim 1 wherein said alkylpyrazole comprises between about 0.1 and 1.0 percent by weight of said electrolyte.

7. The cell of claim 1 wherein said solvent comprises a mixture of 1,3-dioxolane and sulfolane.

8. The cell of claim 1 wherein said solvent comprises a mixture comprising between about 70 and 90 volume percent 1,3-dioxolane and between about 10 and 30 volume percent sulfolane.

9. The cell of claim 1 wherein the lithium salt is selected from the group consisting of LiCF₃SO₃ (LITFS) and Li(CF₃SO₂)₂N (LiTFSI), and mixtures thereof.

10. The cell of claim 1 wherein the lithium salt comprises Li(CF₃SO₂)₂N (LiTFSI).

11. The cell of claim 1 wherein the cathode comprises a coating comprising iron disulfide particles coated onto both sides of a substrate.

12. The cell of claim 1 wherein the anode and cathode are in wound configuration with a separator therebetween.

13. The cell of claim 12 wherein said separator is formed of microporous material comprising polyethylene or polypropylene having a thickness between about 0.008 and 0.025 mm.

14. A primary electrochemical cell comprising a housing; a positive and a negative terminal; an anode comprising at least one of a lithium metal and lithium alloy; a cathode comprising iron disulfide (FeS₂) and conductive carbon, said cell further comprising an electrolyte comprising a lithium salt dissolved in a solvent, wherein said electrolyte comprises an additive comprising an alkylimidazole.

15. The cell of claim 14 wherein said alkylimidazole additive comprises 1,2-dimethylimidazole.

16. The cell of claim 14 wherein said alkylimidazole comprises between about 0.05 and 1.0 percent by weight of said electrolyte.

17. The cell of claim 14 wherein said alkylimidazole comprises between about 0.1 and 1.0 percent by weight of said electrolyte.

18. The cell of claim 14 wherein said solvent comprises a mixture of 1,3-dioxolane and sulfolane.

19. The cell of claim 14 wherein said solvent comprises a mixture comprising between about 70 and 90 volume percent 1,3-dioxolane and between about 10 and 30 volume percent sulfolane.

20. The cell of claim 14 wherein the lithium salt is selected from the group consisting of LiCF₃SO₃ (LITFS) and Li(CF₃SO₂)₂N (LiTFSI), and mixtures thereof.

21. The cell of claim 14 wherein the lithium salt comprises Li(CF₃SO₂)₂N (LiTFSI).

22. The cell of claim 14 wherein the cathode comprises a coating comprising iron disulfide particles coated on both sides of a substrate.

23. The cell of claim 14 wherein the anode and cathode are in wound configuration with a separator therebetween.

24. The cell of claim 23 wherein said separator is formed of microporous material comprising polyethylene or polypropylene having a thickness between about 0.008 and 0.025 mm.
